(19) United States
(12) Patent Application Publication
(10) Pub. No.: US 2011/0019610 A1
(43) Pub. Date: Jan. 27, 2011

(54) METHOD AND APPARATUS FOR PREVENTING TUNNEL LOOPING

(75) Inventors: Desire Oulai, Longueuil (CA); Suresh Krishnan, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/507,456

(22) Filed: Jul. 22, 2009

(51) Int. Cl. H04W 24/02; H04W 40/00; H04L 12/56

(52) U.S. Cl. 370/328; 370/389

(57) ABSTRACT

The present invention relates to a method and apparatus for preventing endless tunnel looping in a mobile communication network. An originating home agent inserts an extended TEL option into a packet that is being forwarded by the originating home agent. The extended TEL option includes an address of the originating home agent and indicates the original tunnel entry point of the packet. When another home agent receives the forwarded packet containing the extended TEL option, the receiving home agent may send a loop risk indicator (LRI) to the originating home agent to inform the originating home agent of the tunnel looping risk. The originating home agent may then use the conventional TEL option for subsequent packets forwarded during that particular mobility session for the mobile terminal.

### TECHNICAL FIELD

The present invention relates generally to Mobile Internet Protocols for providing Internet access to mobile terminals and, more particularly to a method and apparatus to prevent tunnel looping for packets sent to a multi-homed mobile terminal having two or more home agents.

### BACKGROUND

The Internet provides access to information resources worldwide. Users typically gain access to the Internet from a fixed station located in the home, office, school, or other location. Laptop computers and other portable computing devices provided a first step toward mobile Internet access by allowing the user to connect to the Internet through any connection point offered by the users' service provider. Some service providers, such as America Online (AOL), offer nationwide and/or worldwide access networks for their subscribers. However, laptop computers do not provide true mobile Internet access since the laptop's connection to the Internet during any given session is fixed. True mobile access would allow the user to move freely and change the point of connection to the Internet without disrupting service.

The Mobile IP protocol allows a mobile terminal, such as a cellular phone, personal digital assistant, or laptop computer, to access the Internet via a mobile communication network. Mobile IPv4 is described in the Internet Engineering Task Force (IETF) Request For Proposal (RFC) 3344. Mobile IPv6 is described in IETF RFC 3775. The Mobile IP protocol solves the problem of host mobility by using two IP addresses: a fixed home address (HoA) that remains the same regardless of the location of the mobile terminal and a “care of” address (CoA) that changes depending on the location of the mobile terminal. The home address (HoA) is associated with a home agent (HA) that provides mobility services. When a mobile terminal is away from its home network, it sends a binding update (BU) to its home agent to bind the current care of address (CoA) to the home address (HoA). A tunneling protocol can be used to establish a link between the home agent and the care of address (CoA). The home agent can then forward packets for the mobile terminal to the care of address (CoA) thereby allowing the mobile terminal to roam freely within a mobile communication network and to change its point of connection to the Internet without disruption of service.

MIPv6 allows a mobile terminal to have multiple home addresses with the same or different home agents. A mobile terminal with multiple home addresses is referred to herein as a multi-homed mobile terminal. Multi-homing is useful, for example, for load balancing or when the mobile terminal is connected to two different service providers. In the later case, the mobile terminal may have a home agent with each service provider.

Multi-homing creates a potential for tunnel looping problems, which can be either malicious or unintentional. For example, a multi-homed mobile terminal may bind a first home address associated with a first home agent with a second home address associated with a second home agent making the second home address the care of address for the mobile terminal. The first home agent has no means of detecting that the care of address provided by the mobile terminal is another home address. When a packet arrives at the first home agent, the home agent forwards the packet to the second home agent designated by the care of address in the first home agent's binding table. The binding of the second home address, or other subsequent forwarding address, may result in the packet being returned to the first home agent creating an endless loop.

The Generic Packet Tunneling in IPv6 specification described in IETF RFC 2473 provides one mechanism that can be used to avoid tunnel looping. Specifically, excessive nested encapsulation is limited by use of a Tunnel Encapsulation Limit (TEL) option, which is inserted in an IPv6 destination options extension header accompanying an encapsulating IPv6 header. The TEL value is decremented at each tunnel entry point. When the value of the TEL field reaches 0, the packet is dropped. While the TEL option prevents excessive nested encapsulation, it does not enable detection of tunnel looping. The TEL option could be extended to include the identifier of the original tunnel entry point so that the original tunnel entry point can detect when packets are returned. These solutions, however, require every data packet for each mobile terminal to use the TEL option and thus, significantly increase the signaling overhead, which is not desirable for packages transmitted over the radio interface. Thus, mobile service providers are reluctant to use the TEL option.

### SUMMARY

The present invention relates to a method and apparatus for preventing endless tunnel looping in a mobile communication network. According to one embodiment, an extended TEL option is inserted into a packet that is being forwarded by an originating home agent. The extended TEL option includes an address of the originating home agent and indicates the original tunnel entry point of the packet. In one exemplary embodiment, the packet carrying the extended TEL option comprises a binding acknowledgement packet that is transmitted by the originating home agent to the care of address for the mobile terminal in response to a binding update from the mobile terminal. When another home agent for the mobile terminal receives a packet containing the extended TEL option, the receiving home agent may send a loop risk indicator (LRI) to the originating home agent to inform the originating home agent of the tunnel looping risk. The originating home agent may then use the conventional TEL option for subsequent packets forwarded during that particular mobility session for the mobile terminal. The use of the conventional TEL option will result in dropping of packets in the event of a tunnel loop. For mobility sessions where tunnel looping is not a risk, the TEL option does not need to be invoked. The present invention thus significantly reduces signaling overhead by requiring use of the TEL option only when a risk of tunnel looping exists.

Exemplary embodiments of the invention comprise a method implemented by an originating home agent for preventing tunnel looping. One exemplary method comprises generating, during a given mobility session, a tunnel packet including a tunnel entry point identifier; forwarding the tunnel packet containing the tunnel entry point identifier; and inserting a tunnel encapsulation limit into later tunnel packets associated with said mobility session responsive to receipt of a loop risk indicator.

Other exemplary embodiments of the invention comprise an originating home agent for a mobile communication network. One exemplary originating home agent comprises a network interface and a processing unit for processing packets transmitted and received over said network interface. The processing unit is configured to generate, during a given mobility session, a tunnel packet including a tunnel entry point identifier; forward the tunnel packet containing the tunnel entry point identifier; and insert a tunnel encapsulation limit into subsequent tunnel packets associated with said mobility session responsive to receipt of a loop risk indicator.

Exemplary embodiments of the invention comprise a method implemented by a receiving home agent for preventing tunnel looping. One exemplary method comprises receiving a forwarded tunnel packet including a tunnel entry point identifier; and sending a loop risk indicator to a home agent identified by said tunnel entry point identifier.

Other exemplary embodiments of the invention comprise a receiving home agent in a mobile communication network. One exemplary receiving home agent comprises a network interface; and a processing unit for processing packets transmitted and received over said network interface. The processing unit is configured to receive a forwarded tunnel packet including a tunnel entry point identifier; and send a loop risk indicator to a home agent identified by said tunnel entry point identifier.

### BRIEF DESCRIPTION OF THE DRAWINGS

FIG. 1 is a schematic diagram illustrating a communication network implementing mobile IP (MIP).

FIG. 2 is a schematic diagram illustrating the tunneling of packets between a home agent and a foreign agent.

FIG. 3 is a schematic diagram illustrating the problem of tunnel looping.

FIG. 4 is a signal flow diagram illustrating a method of preventing tunnel looping.

FIG. 5 is a flow diagram illustrating a procedure implemented by an originating home agent for preventing tunnel looping.

FIG. 6 is a flow diagram illustrating a procedure implemented by a receiving home agent for preventing tunnel looping.

FIG. 7 is a schematic diagram illustrating an exemplary format of an Extended TEL Option, which is used to prevent tunnel looping.

FIG. 8 is a block diagram illustrating an exemplary mobility agent (e.g., home agent or foreign agent).

### DETAILED DESCRIPTION

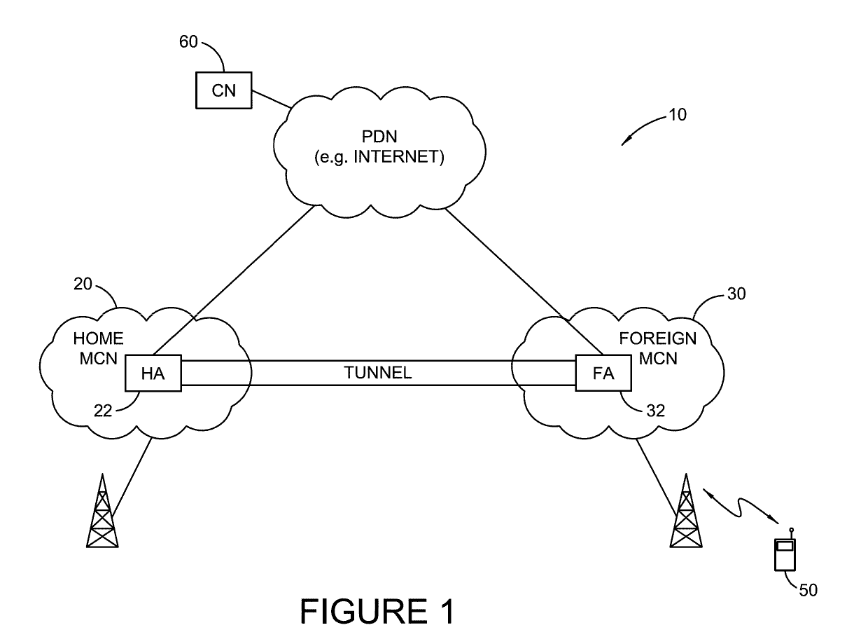

As seen in the drawings, FIG. 1 illustrates an exemplary communication network 10 that provides Internet access to mobile terminals 100. The communication network 10 comprises a home mobile communication network 20 (hereinafter the home network 20), a foreign mobile communication network 30 (hereinafter the foreign network 30), and a wide area packet data network (PDN) 40. The home network 20 and foreign network 30 may comprise a fixed Internet network or a Public Land Mobile Network (PLMN), which may include a core network and a radio access network. The radio access network of the PLMN may be based on any communication standard, such as Wideband CDMA (WCDMA), Long Term Evolution (LTE), or WiMAX. The home network 20 and foreign network 30 could also comprise wireless local area networks (WLANs), which may comprise public or private networks. The packet data network 40 comprises any public or private IP network, such as the Internet.

Both the home network 20 and foreign network 30 include mobility agents (MAs) for providing connection to the PDN 40. A home agent (HA) 22 functions as a mobility agent for a mobile terminal 50 when the mobile terminal 50 is operating in the home network 20. The HA 22 is typically located in the Internet network or in the core network of the home network 20. Similarly, a foreign agent (FA) 32 functions as a mobility agent for the mobile terminal 50 when the mobile terminal 50 is operating in the foreign network 30. The FA 32 is typically located in the Internet network or in the core network of the foreign network 30. The mobile terminal 50 is assigned a permanent IP address which is associated with the home agent 22. When the mobile terminal 50 is operating in the foreign network 30, the mobile terminal 50 registers with the foreign agent 32 and is assigned a temporary address referred to as the care of address. The foreign agent 32 registers the carrier address with the home agent 22 on behalf of the mobile terminal and the home agent 22 updates the mobility binding by associating the care of address of the mobile terminal 50 with its home address. The home agent 22 acknowledges the registration of the care of address to the foreign agent 32, which in turn updates its visitor list by inserting the entry for the mobile terminal 50 and relays the reply to the mobile terminal 50.

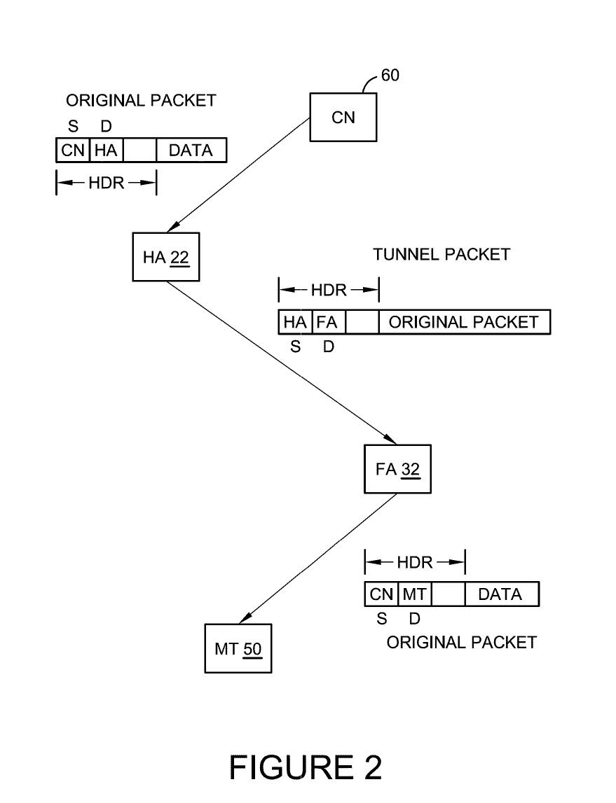

FIG. 2 illustrates how packets are forwarded when a mobile terminal 50 is operating in a foreign network 30. When a corresponding node (CN) 60 wants to communicate with a mobile terminal 50, it sends an IP packet addressed to the home address of the mobile terminal 50, which is routed to the home agent 22 in the home network 20. The home agent 22 consults its binding table to determine the location of the mobile terminal 50. If the mobile terminal 50 is in the foreign network 30, the home agent 22 constructs a new IP header that contains the mobile terminal care of address (the address of the foreign agent) as the destination address and inserts the original IP packet into the payload of the new IP packet. This process of encapsulating one IP packet into the payload of another is known as tunneling. The home agent then forwards the encapsulated packet, referred to herein as a tunnel packet, to the foreign agent 32. When the tunnel packet reaches the foreign agent 32, the foreign agent 32 decapsulates the original IP packet, determines the mobile terminal's home address from the destination address of the original IP packet, and then consults it's visitor list to determine if it has an entry for the mobile terminal 50. If there is an entry for the mobile terminal 50 in the visitor list, the foreign agent 32 delivers the original IP packet to the mobile terminal 50. In this example, the care of address is the mobile terminal 50 address within the foreign network 30. When a mobile terminal 50 wants to send a message to a corresponding node 60 on the Internet 40, it forwards the packet to the foreign agent 32, which in turn relays the original packet to the corresponding node 60 using normal IP routing.

The Mobile Internet Protocol Version 6 (MIPv6) allows a mobile terminal 50 to have multiple home addresses, which may be associated with the same home agent 22 or different home agents 22. For example, the mobile terminal 50 may use different home agents 22 for different services and/or service providers. A mobile terminal 50 having multiple home addresses is referred to herein as a multi-homed mobile terminal 50.

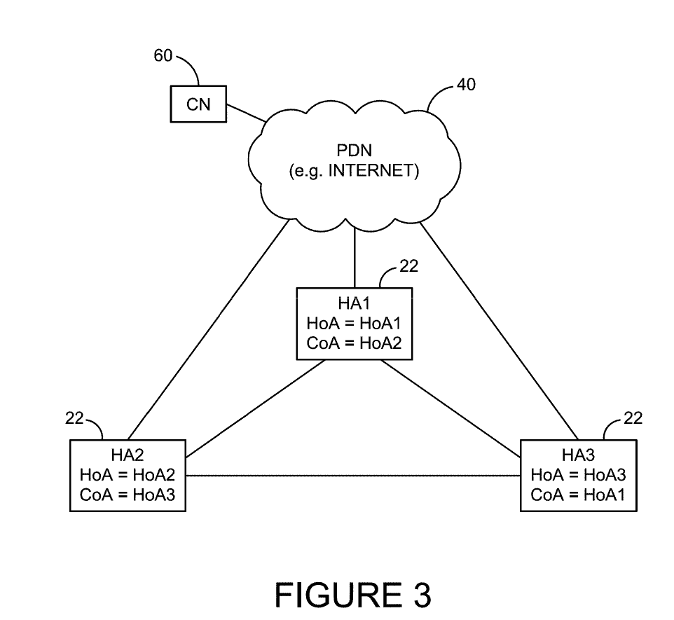

Multi-homing creates a potential for tunnel looping problems, which can be either malicious or unintentional. Tunnel looping occurs when a series of care of addresses returns an original packet to the original tunnel entry point for the packet. FIG. 3 illustrates three home agents 22 for the same mobile terminal 50 denoted as HA1, HA2, and HA3. The mobile terminal 50 has three separate home addresses, one for each of the home agents 22, denoted as HoA1, HoA2, and HoA3. A mobile terminal 50 may, either intentionally or maliciously, register its home address at one home agent 22 as the care of address with a different home agent. In the example shown in FIG. 3, the home address HoA2 associated with HA2 is registered as the care of address with HA1, the home address HoA3 of HA3 is registered with HA2 as the care of address, and the home address HoA1 of HA1 is registered with HA3 as the care of address.

When a corresponding node 60 sends packets to the mobile terminal 50, the packets are routed to one of the home agents 22. In this example, it is assumed that the packets arrive at HA1. HA1 consults its binding table to determine the care of address, encapsulates the original packet in a tunneling packet, and forwards the tunneling packet to HA2. HA2, in turn, consults its binding table to determine the care of address and tunnels the packet to HA3. HA3 receives the tunneling packet from HA2, consults its binding table, and tunnels the packet to HA1, which is the original tunnel entry point for the packet. The tunnels between the home agents 22 thus form a closed loop through which the original packet will be endlessly routed. Each time the packet is tunneled from one home agent 22 to another, a new header is added so that the packet becomes increasingly larger with each hop.

The Generic Packet Tunneling in IPv6 specification described in IETF RFC 2473 provides one mechanism that can be used to avoid tunnel looping. Specifically, excessive nested encapsulation is limited by use of a Tunnel Encapsulation Limit (TEL) option, which is inserted in an IPv6 destination options extension header accompanying an encapsulating IPv6 header. The TEL value is decremented at each tunnel entry point. When the value of the TEL field reaches 0, the packet is dropped. While the TEL option prevents excessive nested encapsulation, it does not enable detection of tunnel looping. The TEL option could be extended to include the identifier of the original tunnel entry point so that the original tunnel entry point can detect when packets are returned. These solutions, however, require every data packet for each mobile terminal to use the TEL option and thus, significantly increase the signaling overhead, which is not desirable for packages transmitted over the radio interface. Thus, mobile service providers are reluctant to use the TEL option.

The present invention provides a method and apparatus to prevent looping in a MIPv6 environment without significantly increasing the signaling load. According to one embodiment, an originating home agent 22 inserts an Extended TEL option into a packet that is being forwarded. The Extended TEL option includes an address of the originating home agent 22 and indicates the original tunnel entry point of the packet. In one exemplary embodiment, the packet carrying the Extended TEL option comprises a binding acknowledgement packet that is transmitted by the originating home agent 22 to the care of address of the mobile terminal 50 in response to a binding update from the mobile terminal 50. Those skilled in the art will appreciate, however, that the Extended TEL option could also be placed in a data packet that is being forwarded to the mobile terminal 50. If the care of address designates a foreign agent 32, the foreign agent 32 will deliver the message to the mobile terminal 50 and the extended TEL option will have no effect. On the other hand, if the care of address given by the mobile terminal 50 designates another home agent 22, the home agent 22 receiving the message will tunnel the packet to the care of address obtained by consulting its own binding tables.

Because the packet contains the original tunnel entry point of the message, the second home agent 22 will know that nested tunneling has occurred. The occurrence of nested tunneling does not mean that a tunnel loop exists. Instead, it means that there is some risk of tunnel looping. In this case, the receiving home agent 22 may send a loop risk indicator (LRI) to the originating home agent 22 to inform the originating home agent 22 of the tunnel looping risk. The originating home agent 22 may then use the conventional TEL option for subsequent packets forwarded during that particular mobility session for the mobile terminal 50. The use of the conventional TEL option will result in dropping of packets in the event of a tunnel loop. The present invention thus significantly reduces signaling overhead by requiring use of the TEL option only when a risk of tunnel looping exists. For mobility sessions where tunnel looping is not a risk, the TEL option does not need to be invoked.

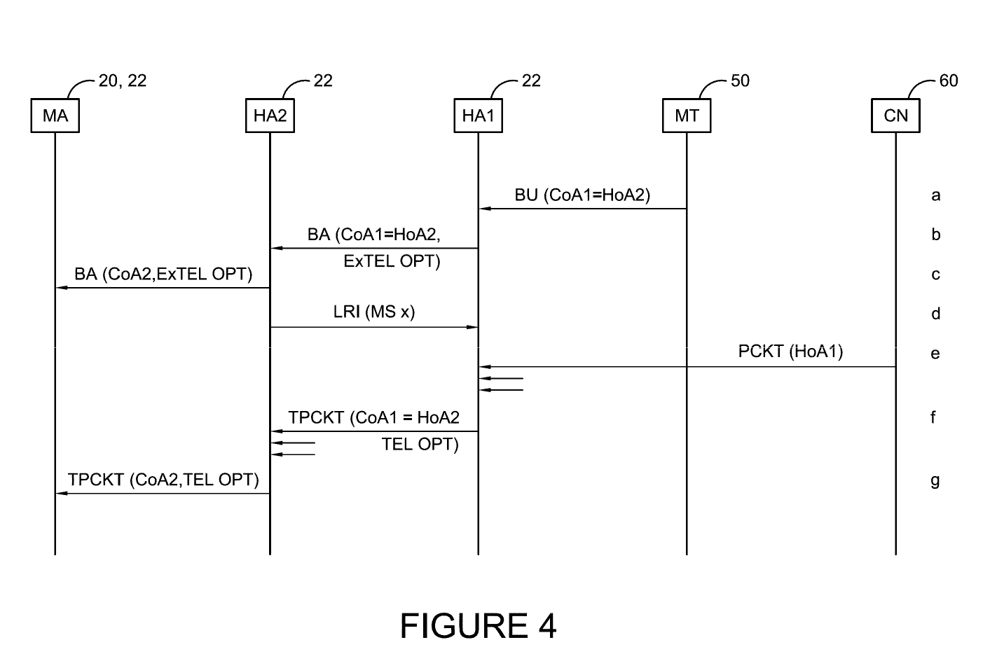

FIG. 4 is a signaling flow diagram illustrating how the loop prevention mechanism works according to one exemplary embodiment. The mobile terminal 50 sends a binding update to an first home agent (HA1) 22 giving the home address of a second home agent (HA2) 22 as the care of address (step a). The first home agent (HA1) 22 updates its binding table to bind the home address (HoA2) of the second home agent (HA2) to the home address (HoA1) of the first home agent (HA1) as the care of address (CoA1). The first home agent (HA1) 22 then sends a binding acknowledgement (BA) to the care of address provided by the mobile terminal 50, which in this example, is the home address (HoA2) of HA2 (step b). The binding acknowledgement includes an Extended TEL Option (ExTEL) designating the home address (HoA1) of HA1 as the original tunnel entry point. HA2 forwards the received packet to another mobility agent (MA), which may comprise another home agent 22 or foreign agent 32 (step c). Those skilled in the art will appreciate that the mobility agent (MA) could also be the originating home agent (HA1). HA2 also sends a loop risk indicator back to HA1 to indicate that nested tunneling has taken place and to inform HA1 that there is some risk of tunnel looping (step d). The LRI includes a session identifier for the mobility session. HA1 can then invoke the conventional TEL option as described in IETF RFC 2473 for all data packets associated with that particular mobility session for the mobile terminal 50.

When subsequent packets arrive at HA1 from a corresponding node (CN) 60 (step e), HA1 tunnels the packets to HA2 (which is designated by the care of address) (step f). The packets tunneled from HA1 to HA2 include the conventional TEL option (TEL OPT) as specified in RFC 2473. HA2 then tunnels the packets to the mobility agent (MA) designated by its own care of address (Step g). Each time the original packet PCKT is tunneled from one home agent 22 to another, the TEL option value is decremented. Therefore, when the TEL option value reaches 0, the mobility agent receiving the multiply encapsulated packet will drop the packet to prevent endless looping.

In some embodiments, the Extended TEL option could also be used in data packets that are being forwarded by the originating home agent 22 to the mobile terminal 50 in addition to the binding acknowledgement message. For example, the originating home agent 22 could be configured to insert the Extended TEL option into data packets at periodic intervals, or responsive to particular events.

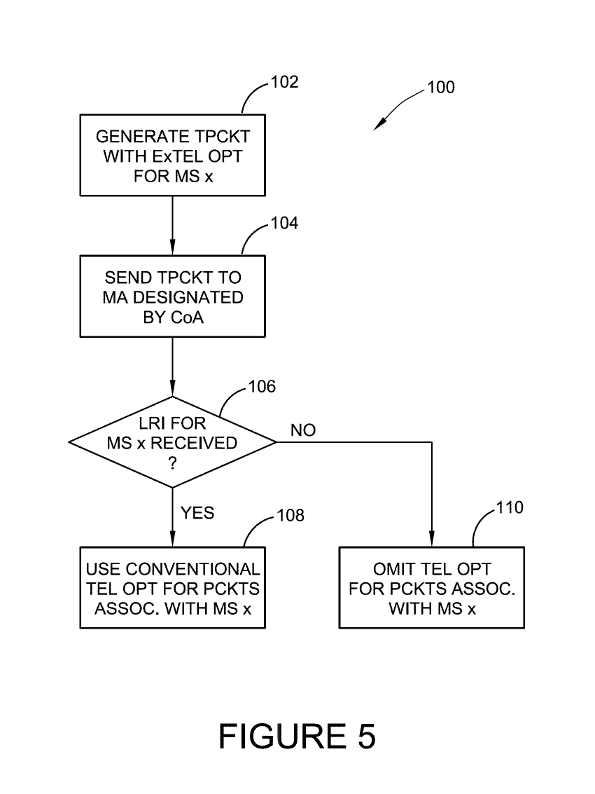

FIG. 5 illustrates an exemplary procedure 100 implemented by an originating home agent (HA) 22 according to one exemplary embodiment. The originating home agent (HA) 22 generates a tunnel packet with an Extended TEL option for mobility session x (block 102) and sends the tunnel packet to the mobility agent designated by the care of address obtained from its own binding table (block 104). The handling of subsequent packets associated with the same mobility session depends on whether the originating home agent (HA) 22 receives a loop risk indicator (block 106). If the home agent 22 receives a loop risk indicator, the home agent 22 uses the conventional TEL option specified by RFC 2473 for all subsequent data packets associated with mobility session x (block 108). On the other hand, if no link risk indicator is received within a predetermined period of time, the home agent (HA) 22 omits the TEL option for packets transmitted during mobility session x (block 110).

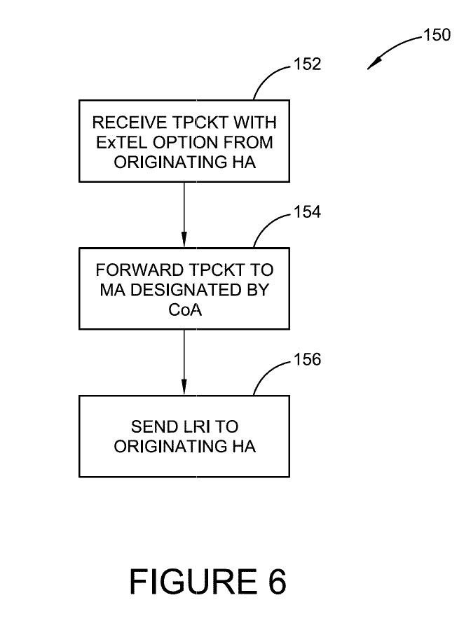

FIG. 6 illustrates an exemplary procedure 150 implemented by a receiving home agent 22. As used herein, the term “receiving home agent” refers to a home agent 22 that receives packets tunneled from a previous home agent 22. The receiving home agent 22 receives tunnel packets with an Extended TEL option from an originating home agent 22 or other preceding home agent 22 (block 152). The receiving home agent 22 forwards the tunnel packet to the mobility agent designated by the care of address given in its binding table (block 104). The receiving home agent 22 recognizes, based on the Extended TEL option, that a tunnel already exists and sends a loop risk indicator (LRI) to the originating home agent 22 (block 156).

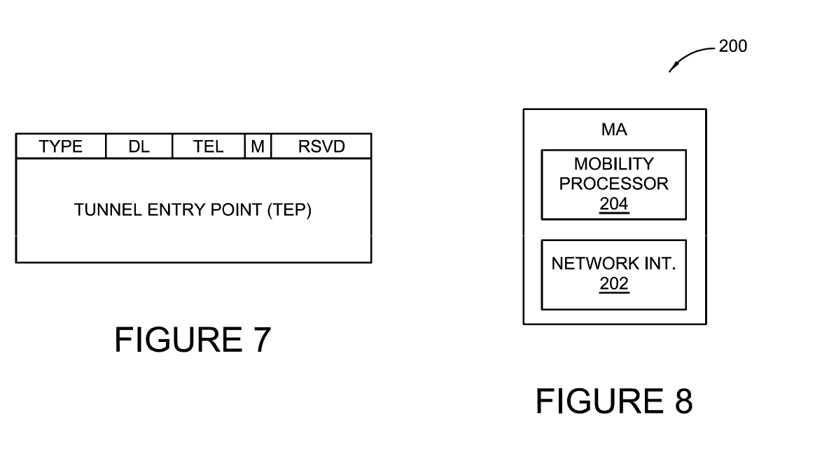

FIG. 7 illustrates the format of the Extended TEL option according to one embodiment of the present invention. The TYPE field indicates the message type, which may be determined by IANA. The DATA LINK (DL) field indicates the length of the message, which indicates that the extended TEL option is 18 bits. The TEL field indicates the tunnel encapsulation limit. The M field comprises a one bit flag indicating that the packet is related to MIP. The TUNNEL ENTRY POINT (TEP) field designates the IP address of the total entry point, which may be different than the one used for mobility purposes.

As previously described, the TEL option may be appended to a binding acknowledgement message, and should preferably be replicated for each new tunnel that the packet passes through. In normal operation, a data packet destined for the mobile terminal 50 should not be encapsulated by more than one home agent (HA) 22. If a home agent (HA) 22 detects the extended TEL option, it will recognize that the packet has already been encapsulated by a preceding home agent 22. Therefore, there is a risk of a tunnel loop. The HA 22 detecting the tunnel loop risk sends a loop risk indicator to the address designated by the TEP field of the extended TEL option. Then, the home agent 22 designated by the tunnel entry point can choose to append a classical TEL option to data packets for the mobility session with the mobile terminal 50. For additional robustness, the initial terminal entry point could also append the extended TEL option to randomly selected data packets at periodic intervals. Mobility agents and other nodes that do not understand the extended TEL option will ignore it.

FIG. 8 illustrates an exemplary mobility agent 200, which may function as either a home agent 22 or a foreign agent 32. The mobility agent 200 may reside in a router, computer, or other host device. The mobility agent 200 comprises a network interface 202 for transmitting and receiving packets over a communication network and a mobility processor 204 for processing the transmitted and received packets. The mobility processor 204 may comprise one or more processors, microcontrollers, hardware, or a combination thereof. The processor that functions as a mobility processor 204 could also handle other functions as well. If the mobility agent 200 comprises a home agent 22, it implements the procedure shown in FIGS. 4-6.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method implemented by an originating home agent in a communication network of preventing tunnel looping, said method comprising:
generating, during a given mobility session, a tunnel packet including a tunnel entry point identifier;
forwarding the tunnel packet containing the tunnel entry point identifier; and
inserting a tunnel encapsulation limit into later tunnel packets associated with said mobility session responsive to receipt of a loop risk indicator.

2. The method of claim 1 further comprising omitting said tunnel encapsulation limit from tunnel packets if no loop risk indicator is received.

3. The method of claim 1 wherein said first tunnel packet comprises a binding acknowledgement.

4. The method of claim 1 wherein said first tunnel packet comprises a data packet.

5. The method of claim 1 wherein generating a tunnel packet including a tunnel entry point identifier is performed periodically.

6. An originating home agent in a mobile communication network, said originating home agent comprising:
a network interface:
a processing unit for processing packets transmitted and received over said network interface, said processing unit configured to:
generate, during a given mobility session, a tunnel packet including a tunnel entry point identifier;
forward the tunnel packet containing the tunnel entry point identifier; and
insert a tunnel encapsulation limit into subsequent tunnel packets associated with said mobility session responsive to receipt of a loop risk indicator.

7. The home agent of claim 6 wherein said processing unit is further configured to omit said tunnel encapsulation limit from tunnel packets if no loop risk indicator is received.

8. The home agent of claim 6 wherein said first tunnel packet comprises a binding acknowledgement.

9. The home agent of claim 6 wherein said first tunnel packet comprises a data packet.

10. The home agent of claim 6 wherein generating a tunnel packet including a tunnel entry point identifier is performed periodically.

11. A method implemented by a receiving home agent in a communication network of preventing tunnel looping, said method comprising:
receiving a forwarded tunnel packet including a tunnel entry point identifier; and
sending a loop risk indicator to a home agent identified by said tunnel entry point identifier.

12. The method of claim 11, further comprising forwarding the received tunnel packet to a designated care of address.

13. A receiving home agent in a mobile communication network, said media agent comprising:
a network interface:
a processing unit for processing packets transmitted and received over said network interface, said processing unit configured to:
receive a forwarded tunnel packet including a tunnel entry point identifier; and
send a loop risk indicator to a home agent identified by said tunnel entry point identifier.

14. The home agent of claim 13 wherein the processing unit is further configured to forward the received tunnel packet to a designated care of address.
